(19) United States
(12) Patent Application Publication
(10) Pub. No.: US 2013/0284010 A1
(43) Pub. Date: Oct. 31, 2013

(54) TELESCOPIC CYLINDER

(71) Applicant: LABRIE ENVIRONMENTAL GROUP INC., Saint-Nicolas (CA)

(72) Inventors: Richard ALLARD, Saint-Nicolas (CA); Edward WELSH, Donnacona (CA)

(73) Assignee: LABRIE ENVIRONMENTAL GROUP INC., Saint-Nicolas (CA)

(21) Appl. No.: 13/870,724

(22) Filed: Apr. 25, 2013

Related U.S. Application Data
(60) Provisional application No. 61/638,566, filed on Apr. 26, 2012.

(51) Int. Cl. F15B 15/00

(52) U.S. Cl. CPC F15B 15/00
USPC 91/157; 91/471

(57) ABSTRACT

A telescopic cylinder comprises a housing, a nestable first sleeve, a nestable second sleeve, and a nestable piston rod. A dividing wall is disposed at at least one of the first ends of the first and the second sleeves thereby defining a first chamber between the housing and the at least one of the first ends of the first and second sleeves, and a second chamber between the at least one of the first ends of the first and second sleeves and the piston rod. A valve extends through the dividing wall for selectively allowing communication from the second chamber to the first chamber when pressure inside the second chamber is above a predetermined pressure. A method of extending a telescopic cylinder where the at least second sleeve extends before the at least first sleeve is also presented.

### TECHNICAL FIELD

The present relates to actuating cylinders, and more specifically to telescopic actuating cylinders.

### BACKGROUND OF THE ART

Telescopic cylinders are used for a variety of purposes. For example, they can provide force for tilting a truck tipper. Like a regular actuating cylinder, a telescopic cylinder comprises a hollow housing and a piston rod coaxially mounted inside the housing. Actuating fluid, usually oil or air, is injected into the cylinder and creates pressure which pushes, or “extends”, the piston rod out of the housing.

In a telescopic cylinder, a plurality of nested tubular sections or sleeves is further provided between the piston rod and the housing. The sleeves act as extensions to the housing to allow the telescopic cylinder to achieve a longer output stroke than a similarly sized regular actuating cylinder.

In a conventional telescopic cylinder, the sleeve closest to the housing, or first sleeve, has the largest cross-section compared to the other sleeves, and when actuating fluid is injected in the housing of the telescopic cylinder, the pressure of the actuating fluid required to thrust the first sleeve is lower than for the other sleeves. As a consequence the first sleeve extends first. When the first sleeve is fully extended and actuating fluid is still injected in the cylinder, the pressure will cause the next sleeve, coaxially nested into the first sleeve, or second sleeve, to extend similarly to described above for the first sleeve. When the second sleeve is fully extended, the following sleeve is the next one to extend, and so on. The piston rod is usually last to extend.

One inconvenient with conventional telescopic cylinders is that one needs to displace large amounts of fluids to extend the first sleeve.

### SUMMARY

According to one aspect, there is provided a telescopic cylinder comprising a housing having a closed housing end and an opposed open housing end. A first sleeve is coaxially nestable at least partially inside the housing. The first sleeve is movable in translation relative to the housing. The first sleeve has a first end located proximate to the closed housing end and an opposed second end. A second sleeve is coaxially nestable at least partially inside the first sleeve. The second sleeve is movable in translation relative to the housing and the first sleeve. The second sleeve has a first end proximate to the first end of the first sleeve, and an opposed second end. A piston rod is coaxially nestable at least partially inside the second sleeve. The piston rod is movable in translation relative to the housing, the first sleeve and the second sleeve. A dividing wall is disposed at at least one of the first ends of the first and second sleeves. The dividing wall defines a first chamber between the housing and the at least one of the first ends of the first and second sleeves, and a second chamber between the at least one of the first ends of the first and second sleeves and the piston rod. A valve extends through the dividing wall for selectively allowing communication from the second chamber to the first chamber when pressure inside the second chamber is above a predetermined pressure.

In one embodiment, the valve includes an override position. In the override position, the valve allows communicating from the second chamber to the first chamber regardless of the pressure inside the second chamber.

In one embodiment, the closed housing end includes an aperture aligned with the valve, and a cover selectively sealing the aperture.

In one embodiment, the piston rod includes a duct allowing fluid communication between the central chamber and a reservoir.

In one embodiment, the telescopic cylinder is a single action cylinder.

In one embodiment, the telescopic cylinder further comprises a check valve disposed in the at least one of the first ends of the first and second sleeves comprising the dividing wall. The check valve allows unidirectional flow from the first chamber to the second chamber.

In one embodiment, the piston rod includes a bore for connecting to a structure to be moved relative to the housing.

In one embodiment, the telescopic cylinder further comprises a first side chamber disposed longitudinally between the housing and the first sleeve, a second side chamber disposed longitudinally between the first sleeve and the second sleeve, and a third side chamber disposed longitudinally between the second sleeve and the piston rod.

In one embodiment, the first side chamber communicates with the second side chamber only when the second sleeve is fully nested within the first sleeve. The second side chamber communicates with the third side chamber only when the piston rod is fully nested within the second sleeve.

In one embodiment, the telescopic cylinder further comprises a check valve disposed in the at least one of the first and second sleeves comprising the dividing wall. The check valve allows fluid communication unidirectionally between associated side chambers disposed adjacent to the at least one of the first and second sleeves. A relief valve is disposed in the first end of the at least one of the first and second sleeves comprising the dividing wall. The relief valve allows fluid communication unidirectionally between at least one of the side chambers disposed between the housing and the at least one of the first and second sleeves, and the first chamber.

In one embodiment, the relief valve allows fluid communication when pressure in the at least one of the side chambers disposed between the housing and the at least one of the first and second sleeves is above a second predetermined pressure.

In one embodiment, the predetermined pressure of the valve extending through the dividing wall is a first predetermined pressure. The predetermined pressure of the relief valve is a second predetermined pressure. The second predetermined pressure is higher than the first predetermined pressure.

In one embodiment, the telescopic cylinder further comprises a check valve disposed in the at least one of the first ends of the first and second sleeves comprising the dividing wall, the check valve allowing unidirectional flow from the first chamber to the second chamber.

In one embodiment, the piston rod includes a first duct allowing fluid communication between the central chamber and a control valve, and a second duct allowing fluid communication between the third side chamber and the control valve.

In one embodiment, the first and second ducts are coaxial.

According to second aspect, there is provided a method of extending a telescopic cylinder including a housing and at least first and second sleeves. The at least first sleeve is movable in translation within the housing and is at least partially nestable within the housing. The at least second sleeve is movable in translation and at least partially nestable within the at least first sleeve. The method comprises the step of extending the at least second sleeve before extending the at least first sleeve.

### BRIEF DESCRIPTION OF THE DRAWINGS

In order that the invention may be readily understood, embodiments of the invention are illustrated by way of example in the accompanying drawings.

FIG. 1 is a longitudinal cross-section view of a telescopic cylinder, in accordance with one embodiment in which the telescopic cylinder is single action, shown in a partially extended position;

FIG. 2 is a longitudinal cross-section view of the telescopic cylinder of FIG. 1, shown in a fully retracted position as part of a first step of an extension sequence;

FIG. 3 is a longitudinal cross-section view of the telescopic cylinder of FIG. 1, shown in a first partially extended position as part of a second step of the extension sequence;

FIG. 4 is a longitudinal cross-section view of the telescopic cylinder of FIG. 1, shown in a second partially extended position as part of a third step of the extension sequence;

FIG. 5 is a longitudinal cross-section view of the telescopic cylinder of FIG. 1, shown in a fully extended position as part of a fourth step of the extension sequence;

FIG. 6 is a longitudinal view cross-section partially cut-away to reveal an interior of a telescopic cylinder in which the telescopic cylinder is double action, in accordance with another embodiment, shown in a fully retracted position;

FIG. 7 is a longitudinal cross-section view of a telescopic cylinder, in accordance with yet another embodiment in which the telescopic cylinder is double action, shown in a partially extended position;

FIG. 8 is the longitudinal cross-section view of the telescopic cylinder of FIG. 7, shown in a fully retracted position;

FIG. 9 is the longitudinal cross-section view of the telescopic cylinder of FIG. 7, shown in a first partially extended position as part of a first step of an extension sequence;

FIG. 10 is the longitudinal cross-section view of the telescopic cylinder of FIG. 7, shown in a second partially extended position as part of a second step of the extension sequence;

FIG. 11 is the longitudinal cross-section view of the telescopic cylinder of FIG. 7, shown in a third partially extended position as part of a third step of the extension sequence;

FIG. 12 is the longitudinal cross-section view of the telescopic cylinder of FIG. 7, shown in a fully extended position as part of a fourth step of the extension sequence;

FIG. 13 is the longitudinal cross-section view of the telescopic cylinder of FIG. 7, shown in a first partially retracted position as part of a first step of a retraction sequence;

FIG. 14 is the longitudinal cross-section view of the telescopic cylinder of FIG. 7, shown in a second partially retracted position as part of a second step of the retraction sequence;

FIG. 15 is the longitudinal cross-section view of the telescopic cylinder of FIG. 7, shown in a third partially retracted position as part of a third step of the retraction sequence; and

FIG. 16 is the longitudinal cross-section view of the telescopic cylinder of FIG. 7, shown in a fully retracted position as part of a fourth step of the retraction sequence; and

FIG. 17 is a trash compacting system using the telescopic cylinder of FIG. 7.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

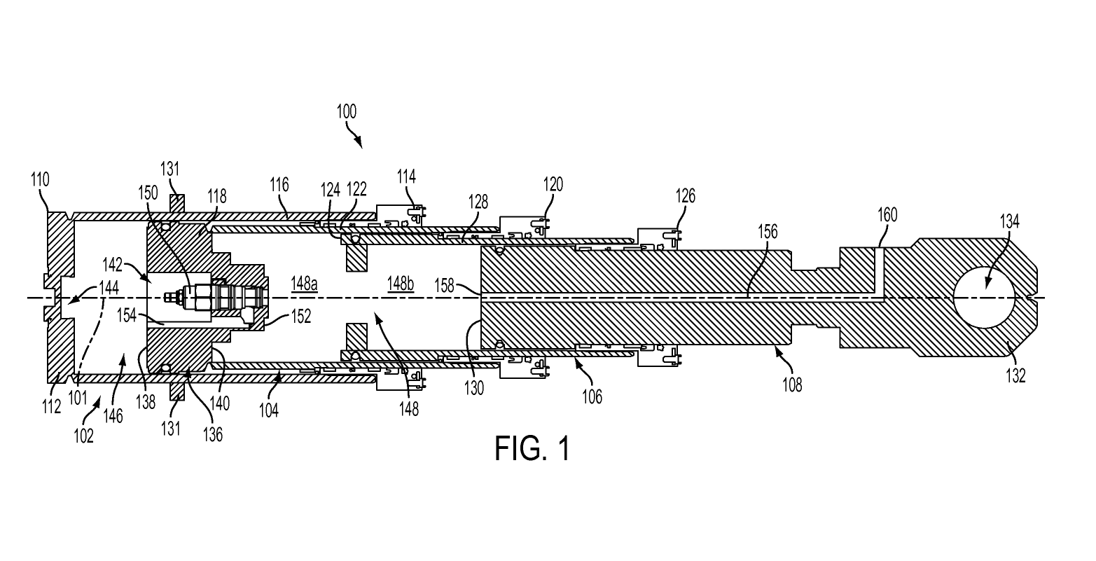

Referring to FIG. 1, there is shown a telescopic cylinder 100, in accordance with a first embodiment.

The telescopic cylinder 100 is a single action cylinder. The telescopic cylinder 100 is used for moving a movable structure relative to a stationary one. For example, the telescopic cylinder 100 has one end connected to the bin of a dump truck (i.e. the movable structure) and the other end connected to the bed of the dump truck (i.e. the stationary structure). In one example, the piston 108 would engage the mobile structure while the housing 102 would engage the fixed structure. Although the telescopic cylinder 100 uses gravity as a retraction force (and is thus used in a generally vertical plane), it is contemplated that the telescopic cylinder 100 could have a retraction system and be used at an angle with a generally vertical axis. Such telescopic cylinders could be used, for example horizontally. These retraction systems could include spring or counterweight. It is contemplated that the telescopic cylinder 100 could be used between two movable structures. Double action telescopic cylinders will be described below.

The telescopic cylinder 100 comprises a housing 102, a first sleeve 104, a second sleeve 106 and a piston rod 108 which are nestable within each other and movable away from each other along a common longitudinal axis 101. It is contemplated that the telescopic cylinder 100 could have more than two sleeves.

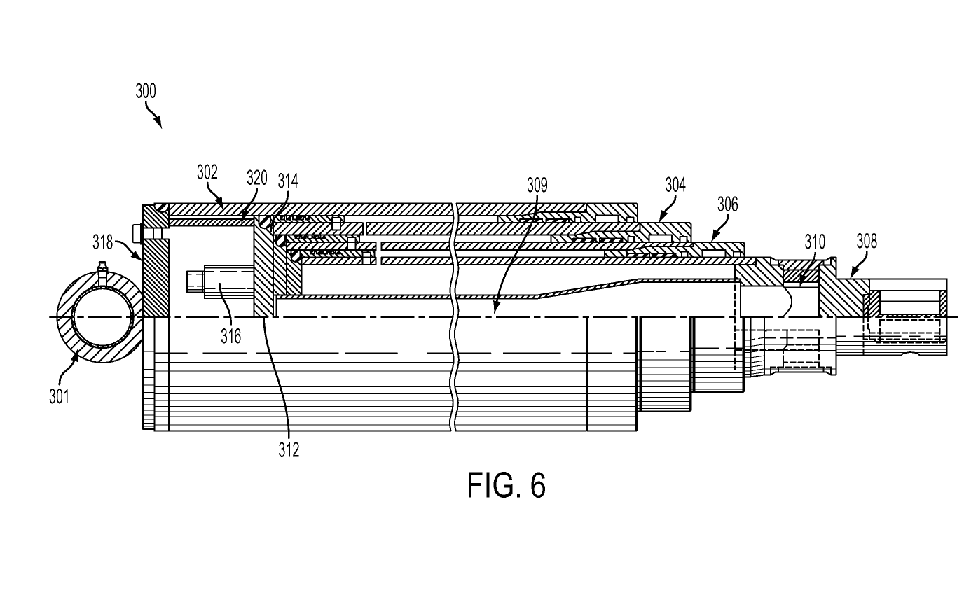

The housing 102 has a generally cylindrical shape defined by a housing sidewall 116. The housing sidewall 116 has a first end 110 closed by an end wall 112, and a second end 114 opposite to the first end 110 with respect to the housing sidewall 116. The second end 114 is open. Although in the illustrated embodiment, the housing 102 has a generally circular cross-section, the housing 102 could instead have a rectangular cross-section or a cross-section of any other shape that would be deemed appropriate by a skilled person for the contemplated use of the telescopic cylinder 100. The housing 102 is attached to a structure by a trunion 131. It is contemplated that the housing 102 could be instead attached to the structure by, for example, an attachment ring similar to the one shown in FIG. 6.

The first sleeve 104 is coaxially nested within the housing 102. The first sleeve 104 has a generally cylindrical shape defined by a first sleeve sidewall 122. The first sleeve sidewall 122 has a first end 118 closed by a dividing wall 136, and a second end 120 opposite to the first end 118 with respect to the first sleeve sidewall 122. The dividing wall 136 is welded to the first sleeve sidewall 122. It is contemplated that the dividing wall 136 could be secured to the first sleeve sidewall 122 by other means. For example, the dividing wall 136 and the sidewall 122 of the first sleeve 104 could be integrally formed, thereby defining a unitary body. The dividing wall 136 will be described in greater detail below. The second end 120 is open. The first sleeve 104 is movable longitudinally relative to the housing 102. The first sleeve 104 has a cross-section having a shape matching a shape of the cross-section of the housing 102. In the illustrated embodiment, the first sleeve 104 has a circular cross-section similar to the one of the housing 102. It is contemplated however that the first sleeve 104 and the housing 102 could have different cross-sections. The first sleeve 104 has a diameter slightly less than the diameter of the housing 102 and fits in a generally snug manner inside the housing 102. It is contemplated, that the first sleeve 104 could fit more or less snugly inside the housing 102. In some cases, such as the one of double action cylinders, some of which will be described below, there could be a substantial space located between each of the sleeves 104, 106 and the housing 102 thereby defining side chambers therebetween. In an example of a double action cylinder, the housing 102 has a diameter of 6 inches (15.24 cm) and the first sleeve 104 has a diameter about 0.50 inches (0.635 cm) lesser than the diameter of the housing 102. The first sleeve 104 and the housing 102 define an end chamber 146 of variable volume. The end chamber 146 is defined by a variable portion of the housing sidewall 116 depending on a position of the first sleeve 104 with respect to the housing 102, the first end wall 112 and the dividing wall 136. Relative movement of the first sleeve 104 with respect to the housing 102 will be described in details below.

The second sleeve 106 is coaxially nested within the first sleeve 104. The second sleeve 106 is generally similar to the first sleeve 104. The second sleeve 106 has a generally cylindrical shape defined by a second sleeve sidewall 128. The second sleeve sidewall 128 has a first end 124 that is open, and a second end 126 opposite to the first end 124 with respect to the second sleeve sidewall 128. The second end 126 is also open. The second sleeve 106 has a cross-section matching the one of the cross-section of the first sleeve 104. It is contemplated that the second sleeve 106 could have a shape different from the first sleeve 104. Furthermore, the second sleeve 106 has a diameter slightly less than the diameter of the first sleeve 104 and fits in a generally snug manner inside the housing 102. Similarly to what has been described above with respect to the first sleeve 104 and the housing 102, it is contemplated that the second sleeve 106 could fit more or less snugly inside the first sleeve 104, and that a substantial space could be located between the second sleeve 106 and the first sleeve 104. Relative movement of the second sleeve 106 with respect to the first sleeve 104 will be described in details below. The second sleeve 106 and the first sleeve 104 define a first sub-chamber 148a of variable volume. The first sub-chamber 148a is defined by a variable portion of the first sleeve side wall 122 (depending on the position of the second sleeve 106 with respect to the first sleeve 104), the first end 124 of the second sleeve 106 and the dividing wall 136.

The piston rod (or piston) 108 is coaxially nested within the second sleeve 106. The piston 108 comprises a first end 130 and an opposite second end 132. The piston 108 is movable longitudinally relative to the second sleeve 106 as will be described below. The piston 108 and the second sleeve 106 define a second sub-chamber 148b of variable volume. The second sub-chamber 148b is defined by a variable portion of the second sleeve sidewall 128, the piston 108 and the first end 124 of the second sleeve 106. The first end 124 being open, the sub-chambers 148a and 148b communicate freely with each other and form a central chamber 148.

The second end 132 of the piston rod 108 includes a bore 134. The bore 134 is used, for example, to secure the piston rod 108 to the stationary structure in a clevis-type arrangement. It will be appreciated that the second end 132 of the piston rod 108 may be secured to the stationary structure using any other fastening means known to the skilled addressee. Alternatively, instead of being fastened to the stationary structure, the second end 132 of the piston rod 108 may simply abut the stationary structure.

The piston 108 includes a fluid duct 156. The fluid duct 156 comprises a first port 160 receiving actuating fluid from a fluid source (e.g. reservoir with a hydraulic pump and a control valve), and a second port 158 in communication with the central chamber 148. The actuating fluid is oil. It is contemplated, however, that the actuating fluid may be another hydraulic fluid, or air or any other actuating fluid which the person skilled in the art may deem appropriate. It is contemplated that the fluid duct 156 could instead be defined elsewhere on the telescopic cylinder 100, as long as the fluid duct 156 is in communication with the central chamber 148. The first port 160 acts as an inlet port and as an outlet port depending on when the telescopic cylinder 100 is being extended and when the telescopic cylinder 100 is being retracted. This way, the actuating fluid flows from the fluid reservoir via the hydraulic pump and the control valve (not shown) into the central chamber 148 to extend the telescopic cylinder 100 and flows out of the central chamber 148 back into the reservoir to retract the telescopic cylinder 100, as will be explained below.

The dividing wall 136 includes a first face 138 facing the closed housing end 110 and an opposed second face 140 facing the second end 120 of the first sleeve 104. A recess 142 is defined in the first face 138 of the dividing wall 136. As illustrated in a second embodiment of the telescopic cylinder 600 below with reference to FIG. 6, the recess 142 could be omitted and replaced by an abutment surface. The recess 142 illustrated herein has a circular cross-section. It is however contemplated that the recess 142 could have any other cross-section deemed appropriate by a skilled person. The recess 142 is axially aligned with an end wall recess 144 defined in the housing end wall 112. In one embodiment, the end wall recess 144 has a circular cross-section corresponding to the cross-section of the recess 142, but may instead have any other shape deemed appropriate by a skilled person. The recess 142 accommodates a sequence valve 150. The sequence valve 150 will be described below.

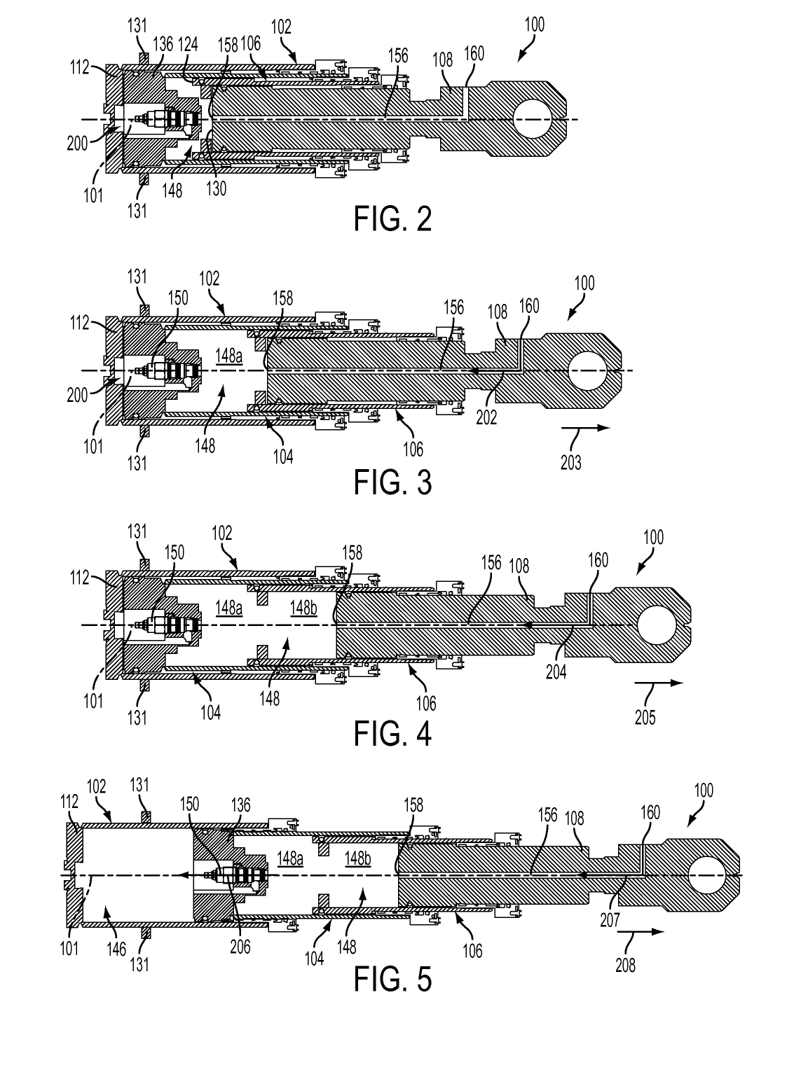

When the first sleeve 104 is fully retracted inside the housing 102, the recess 142 and the end wall recess 144 are adjacent each other and together form an end cavity 200 (best shown in FIG. 2). It is contemplated that the telescopic cylinder 100 could be designed such that when the first sleeve 104 is fully retracted inside the housing 102, the dividing wall 136 and the housing end wall 112 are adjacent to each other but do not form an end cavity.

The dividing wall 136 further comprises a projecting portion 152 extending away from the second face 140 of the dividing wall 136. A communication channel 154 extends radially in the projecting portion 152 to allow communication between the end chamber 146 and the valve 150. Depending on the configuration of the valve 150, the dividing wall 136 could have any other shapes and configurations deemed appropriate by the skilled addressee than the ones described herein.

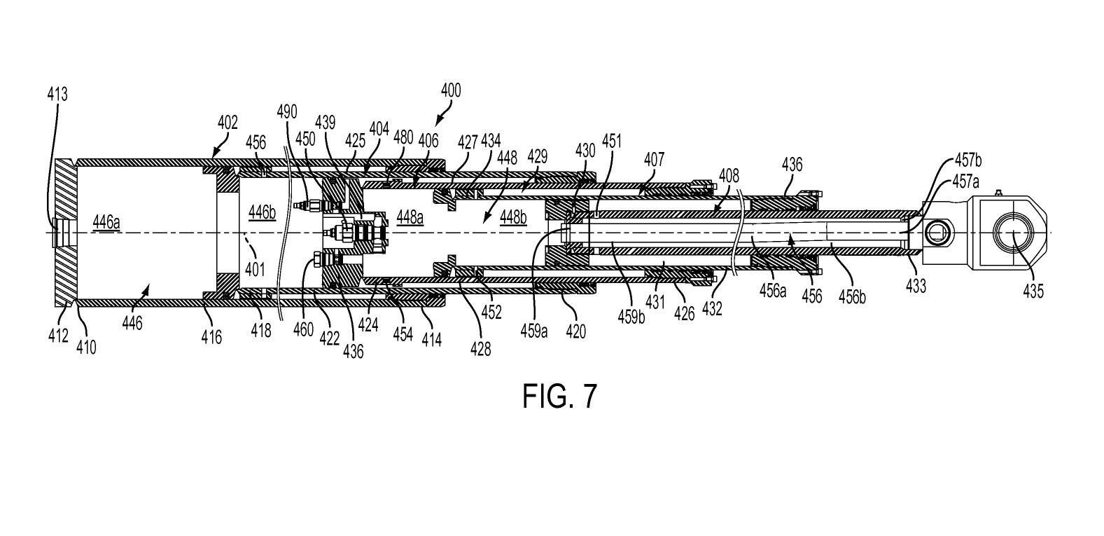

The valve 150 is a sequence valve designed to allow fluid flow from the central chamber 148 to the end chamber 146 when the fluid pressure in the central chamber 148 is above a predetermined pressure. In one embodiment, the predetermined pressure is 2700 psi. The valve 150 is a SQFB-LAN valve manufactured by Sun Hydraulics. It is contemplated that the sequence valve 150 could be any other valve that would be deemed appropriate by a skilled person. The opening and closing of the valve 150 are controlled mechanically, by using a spring system (not shown) calibrated to the predetermined pressure. It is contemplated that other mechanical system could control the opening and closing of the valve 150. It is also contemplated that the valve 150 could also be operatively connected to a sensor which measures pressure inside the central chamber 148 and opens the valve 150 when the measured pressure is greater than the predetermined pressure. It is contemplated that the valve 150 could be adjustable to different predetermined pressures. The valve 150 includes an override position in which the valve 150 is maintained in an open state during operation of the telescoping cylinder 100 (i.e. override position). The override position is actuated after the pressure inside the central chamber 148 is greater than the predetermined pressure whatever the pressure inside the central chamber 148 becomes afterwards and until a retraction sequence begins. It is contemplated that the valve 150 could be manually adjustable. For instance, instead of being integral with the housing sidewall 116, the housing end wall 112 could instead be removably connected to the closed housing end 110. To adjust the sequence valve 150, the user would remove the housing end wall 112 to thereby gain access to the valve 150. Alternatively, as shown for the telescopic cylinder 400 in FIG. 7, the housing end wall 112 could be provided with an opening and a plug removably engaging the opening, such that removal of the plug would provide access to the valve 150 and removing of the entire housing end wall 112 wouldn't be needed. It is also contemplated that the valve 150 could not have an override position.

Turning now to FIGS. 2 to 5, a sequence of operation of the telescopic cylinder 100 now will be described.

Referring to FIG. 2, the telescopic cylinder 100 is shown in a fully retracted position. In this position, the telescopic piston 100 has a minimal length. In the fully retracted position, the dividing wall 136 abuts the end wall 112, the first end 124 of the second sleeve 106 is located near the dividing wall 136 and the first end 130 of the piston rod 108 is located near the first end 124 of the second sleeve 106. The extension sequence begins with actuating fluid introduced in the central chamber 148 through the fluid duct 156 (illustrated by arrow 202 in FIG. 3). It is contemplated that in the fully retracted position, there could be one or more of the dividing wall 136 being somewhat distant from the end wall 112, and/or the first end 124 of the second sleeve 106 being somewhat distant from the dividing wall 136 and/or the first end 130 of the piston rod 108 being somewhat distant from the first end 124 of the second sleeve 106. An example of such position is shown in FIG. 6.

Referring to FIG. 3, the telescopic cylinder 100 is shown in a first partially extended position. The actuating fluid has created pressure on the second sleeve 106 and the piston 108 thereby extending the second sleeve 106 relative to the first sleeve 104 and the housing 102 (illustrated by arrow 203 in FIG. 3). The piston 108 however has not substantially moved relative to the second sleeve 106. This is because the surface area of the piston 108 is smaller than the one of the second sleeve 106 and as a consequence the force to move the piston 108 is greater than the one to move the second sleeve 106 for the same pressure applied. More actuating fluid is still being introduced in the central chamber 148 through the fluid duct 156 (illustrated by arrow 204 in FIG. 4).

In FIG. 4, the telescopic cylinder 100 is shown in a second partially extended position. Actuating fluid has continually been introduced, and the second sleeve 106 being already fully extended, the piston 108 is forced to move relative to the second sleeve 106 (illustrated by arrow 205 in FIG. 4). The piston rod 108 becomes fully extended. Once both the second sleeve 106 and the piston rod 108 are fully extended, the pressure from the actuating fluid starts to build inside the central chamber 148.

Referring to FIG. 5, the pressure inside the central chamber 148 reaches the predetermined pressure threshold, which causes the sequence valve 150 to open (illustrated by arrow 206 in FIG. 5). More actuating fluid is being introduced in the central chamber 148 through the fluid duct 156 (see arrow 207 in FIG. 5), and can now begin to flow into the end cavity 200 to move the first sleeve 104 relative to the housing 102 thereby forming chamber 146 (illustrated by arrow 208 in FIG. 5). Should the actuating fluid be on purpose at a pressure lower than the predetermined pressure threshold, the valve 150 would not open, and only a partial extension of the telescopic cylinder 100 would then be realised.

In FIG. 5, the telescopic cylinder 100 is shown in a fully extended position. It will be understood that the term “fully extended” as used herein in relation with FIG. 5 means that the first sleeve 104, the second sleeve 106 and the piston rod 108 are fully extended. It is contemplated that in other cases the fully extended position could correspond to a partially extended.

A skilled person will appreciate that by allowing the second sleeve 106 and the piston rod 108 to extend before the first sleeve 104, the telescopic cylinder 100 allows the user to stop extension of the telescopic cylinder 100 before the first sleeve 104 extends. This allows less actuating fluid to be used in operations in which a shorter stroke is needed, while still allowing a longer stroke to be obtained by providing more pressure to let the valve 150 open.

It will also be appreciated that since the housing 102 has a larger diameter than the second sleeve 104, it would require a larger volume of actuating fluid to extend the first sleeve 104 by a certain distance than to extend the second sleeve 106 by the same distance. Therefore, if the user does not want the telescopic cylinder 100 to be fully extended, but only wants to extend two sleeves to obtain a shorter stroke, it may be advantageous to extend only the second sleeve 106 and the piston rod 108 instead of the first sleeve 104 and the second sleeve 106 since less actuating fluid would be required.

Furthermore, it will also be appreciated that instead of being positioned at the first end 118 of the first sleeve 104, the dividing wall 136 may be positioned at the first end 124 of the second sleeve 106, in which case the piston rod 108 would extend first, followed by the first sleeve 104 and then the second sleeve 106. In embodiments where the telescopic cylinder 100 has more than two sleeves, the dividing wall 136 may be positioned at the closed end of any sleeve. It is also contemplated that each sleeve of the telescopic cylinder could comprise a dividing wall with an associated valve, such that the sleeves extend sequentially from the piston rod to the most external movable sleeve.

To retract the telescopic cylinder 100 from the fully extended position, the user controls the control valve associated to the reservoir to stop introducing actuating fluid in the telescopic cylinder 100. Gravity pushed the actuating fluid away from the chamber 148 via the duct 156. The first port 160 now functions as an outlet port. The he piston 108 is forced to retract within the second sleeve 106. Once the piston 108 is retracted within the second sleeve 108 and fluid is continuously pushed out of the second sub-chamber 148b, the second sleeve 106 retracts within the first sleeve 104. A check valve (not shown) extending through the dividing wall 136 allows the actuating fluid to pass unidirectionally from the end chamber 146 to the central chamber 148 and finally to the duct 156.

While, the telescopic cylinder 100 may be manufactured from scratch, it is possible to modify an existing conventional cylinder into the telescopic cylinder 100 by adding the dividing wall 136 and the valve 150.

Turning now to FIG. 6, a first embodiment of a double action telescopic cylinder 300 will be described.

The telescopic cylinder 300 is a double action cylinder having an overall configuration substantially similar to the telescopic cylinder 100 shown in FIGS. 1 to 5. The telescopic cylinder 300 comprises a housing 302, a first sleeve 304, a second sleeve 306 and a hollow piston rod 308. The housing 302 includes an attachment ring 301 to connect to fixed structure. It is contemplated that the housing 302 could instead have a trunion. A conduit 309 is defined inside the hollow piston rod 308 to direct actuating fluid introduced through an inlet opening 310 towards a dividing wall 312 located at a first end 314 of the first sleeve 304. In this embodiment, the telescopic cylinder 300 comprises a sequence valve 316 which extends from the dividing wall 312 towards a closed end 318 of the housing 302. To prevent the sequence valve 316 from interfering with the closed end 318 of the housing 302 and from being thereby damaged, the telescopic cylinder 300 is provided with a spacer tube 320 which is long enough to prevent the sequence valve 316 from contacting the closed end 318 of the housing 302 when the spacer tube 320 abuts the closed end 318 of the housing 302 and the dividing wall 312. A functioning of a double action cylinder will be described below. It is contemplated that the cylinder 300 could be a single action cylinder with the spacer tube 320.

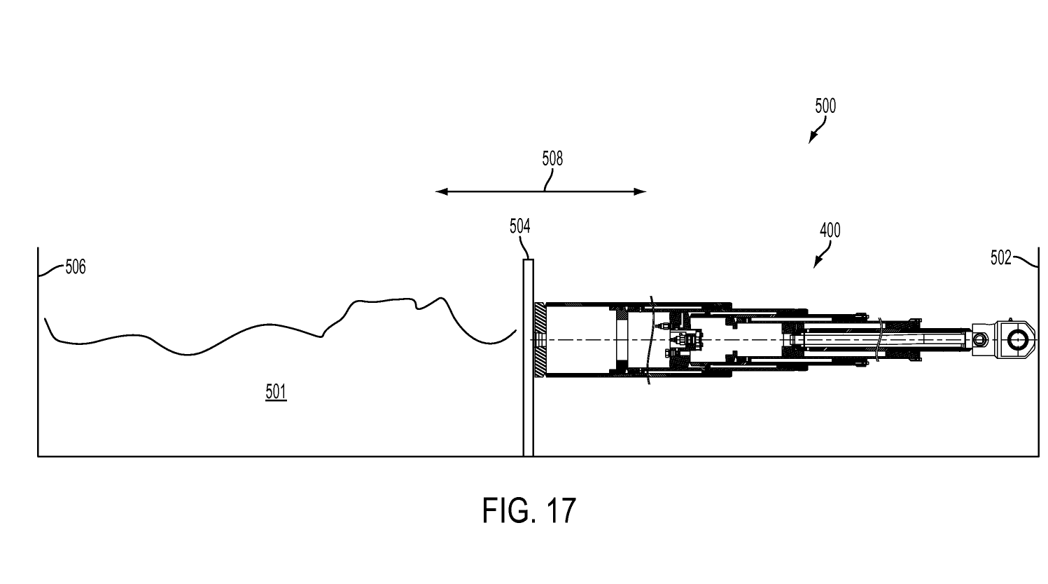

Turning now to FIGS. 7 to 15, a second embodiment of a double action telescopic cylinder 400 will be described. The telescopic cylinder 400 is used for displaying a movable structure relative to a stationary one. It is contemplated that the telescopic cylinder 400 could be connected to two movable structures. In one example, illustrated in FIG. 17 the telescopic cylinder 400 has one end connected to a compacting wall 504 of a trash compacting system 500 (i.e. the movable structure) and another end connected to an attachment wall 502 of the trash compacting system 500 (i.e. the stationary structure). Trash 501 is compacted by the motion of the compacting wall 504 against an abutment wall 506 (illustrated by arrow 508 in FIG. 17). The abutment wall 506 is fixed relative to the attachment wall 502, and is disposed such that the telescopic cylinder 400 is in between the attachment wall 502 and the abutment wall 506.

Because the telescopic cylinder 400 is a dual action cylinder, there is no limitation to the spatial position of the telescopic cylinder 400. The telescopic cylinder 400 may be disposed vertically, horizontally or at an angle. Movement of the telescopic cylinder 400 will be described below.

Referring to FIG. 7, the telescopic cylinder 400 has similarities with the telescopic cylinder 100. It is includes a housing 402, a plurality of sleeves 404, 406, 407, and a piston 408. The housing 402, the plurality of sleeves 404, 406, 407, and the piston 408 are nestable within each other and movable away from each other along a common longitudinal axis 401. It is contemplated that the telescopic cylinder 400 could have only two sleeves, or more than three sleeves. The telescopic cylinder 400 being a double action cylinder, it differs from the telescopic cylinder 100 in that it includes a plurality of side chambers 425, 427, 429, 431 which, when filled by an actuating fluid, provide a forced retraction of their associated sleeves 404, 406, 407 and piston 408. As such, the telescopic cylinder 400 does not rely on gravity, thereby allowing its use at positions other than vertical. The side chambers 425, 427, 429, 431 and the forced retraction will be described below.

Referring more specifically to FIG. 7, the housing 402 has a generally cylindrical shape defined by a housing sidewall 416. The housing sidewall 416 has a first end 410 closed by an end wall 412, and a second end 414 opposite to the first end 410 with respect to the housing sidewall 416. The second end 414 is open. Although in the illustrated embodiment, the housing 402 has a generally circular cross-section, the housing 402 could instead have a rectangular cross-section or a cross-section of any other shape that would be deemed appropriate by a skilled person for the contemplated use of the telescopic cylinder 400. The end wall 412 includes a removable plug 413. The removable plug 143 allows access to internal components of the telescopic cylinder 400 such as valves (described below) for maintenance. It is contemplated that the end wall 412 could not include the removable plug 413 and that it would need to be removed to access the internal components similarly to the telescopic cylinder 300. The housing 402 is connected to a fixed structure via a trunion (not shown). It is contemplated that the housing 402 could instead be connected to a movable structure.

The first sleeve 404 is coaxially nestable within the housing 402. The first sleeve 404 has a generally cylindrical shape defined by a first sleeve sidewall 422. The first sleeve sidewall 422 has a first open end 418, and a second open end 420 opposite to the first end 418 with respect to the first sleeve sidewall 422. The first sleeve 404 is movable longitudinally relative to the housing 402. As such, a first end sub-chamber 446a is defined by a variable portion of the housing sidewall 416, the end wall 412 and the first end 418 of the first sleeve 404. The first sleeve 104 has a cross-section having a shape matching a shape of the cross-section of the housing 402. In the illustrated embodiment, the first sleeve 404 has a circular cross-section similar to the one of the housing 402. It is contemplated however that the first sleeve 404 and the housing 402 could have different cross-sections. The first sleeve 404 has a diameter smaller than the diameter of the housing 402, thereby defining a first side chamber 425 therebetween.

The second sleeve 406 is coaxially nestable within the first sleeve 404. The second sleeve 406 is generally similar to the first sleeve 404. The second sleeve 406 has a generally cylindrical shape defined by a second sleeve sidewall 428. The second sleeve sidewall 428 has a first end 424 closed by a dividing wall 436, and a second end 426 opposite to the first end 124 with respect to the second sleeve sidewall 428. The second end 426 is open. The dividing wall 436 being similar to the dividing wall 136 of the telescopic cylinder 100, it will not be described in detail herein again.

The second sleeve 406 has a cross-section matching the cross-section of the first sleeve 404. It is contemplated that the second sleeve 406 could have a shape different from the first sleeve 404. Furthermore, the second sleeve 406 has a diameter smaller than the diameter of the first sleeve 104, thereby defining a second side chamber 427 therebetween. The second sleeve 406 is movable longitudinally with respect to the first sleeve 407. As such a second end sub-chamber 446b is defined by a variable portion of the first sleeve side wall 422, the first end 418 of the first sleeve 404 and the dividing wall 436. The first and second end sub-chambers 446a,b communicated freely with each other thereby defining an end chamber 446. The dividing wall 436 comprises a sequence valve 450 which allows communication from a central chamber 448 (described below) to the end chamber 446 when pressure in the central chamber 448 is above a predetermined pressure. In one example, the predetermined pressure is 2300 psi. The valve 450 is similar to the valve 150 and will not be described herein again. A communication channel 439 in the dividing wall 436 allows communication between the end chamber 446 and the valve 450. Relative movement of the first and second sleeves 404, 406 with respect to the housing 402 will be described in details below.

The third sleeve 407 is coaxially nestable within the second sleeve 406. The third sleeve 407 is generally similar to the first sleeve 404. The third sleeve 407 has a generally cylindrical shape defined by a third sleeve sidewall 432. The third sleeve sidewall 432 has a first end 434 that is open, and a second end 436 opposite to the first end 434 with respect to the third sleeve sidewall 432. The second end 436 is also open. The third sleeve 407 has a cross-section matching the one of the cross-section of the second sleeve 406. It is contemplated that the third sleeve 407 could have a shape different from the second sleeve 406. Furthermore, the third sleeve 407 has a diameter slightly smaller than the diameter of the second sleeve 406, thereby defining a third side chamber 431 therebetween. The second sleeve 406 and the third sleeve 407 define a first central sub-chamber 448a of variable volume. The first central sub-chamber 448a is defined by a variable portion of the second sleeve side wall 428 (depending on the position of the third sleeve 407 with respect to the second sleeve 406), the first end 434 of the third sleeve 407 and the dividing wall 436.

The piston rod (or piston) 408 is coaxially nestable within the third sleeve 407. The piston 408 comprises a first end 430, and an opposite second end 433. The piston 408 is movable longitudinally relative to the third sleeve 407 as will be described below. The piston 408 and the third sleeve 407 define a second central sub-chamber 448b of variable volume. The second central sub-chamber 448b is defined by a variable portion of the third sleeve sidewall 432, the piston 408 and the first end 434 of the third sleeve 407. The first end 434 being open, the first and second central sub-chambers 448a, 448b communicate freely with each other. The first and second central sub-chambers 448a and 448b form a central chamber 448.

The second end 433 of the piston rod 408 includes a bore 435. The bore 435 is used, for example, to secure the piston rod 408 to the stationary structure in a clevis-type arrangement. It will be appreciated that the second end 432 of the piston rod 408 may be secured to the stationary structure using any other fastening means known to the skilled addressee. Alternatively, instead of being fastened to the stationary structure, the second end 433 of the piston rod 408 may simply abut the stationary structure.

The piston 408 includes a fluid duct 456 connected to a reservoir (not shown). The duct 456 includes a first duct 456a and a second coaxial duct 456b. The first and second ducts 456a, 456b contain the same actuating fluid and have first ends 459a,b that communicate with the control valve linked to the reservoir. The actuating fluid is oil, but it is contemplated that the actuating fluid could be another hydraulic fluid or air for example. The first duct 456a has a second end 459a in communication with the central chamber 448. The second duct 456b has a second end 459b in communication with the fourth side chamber 431.

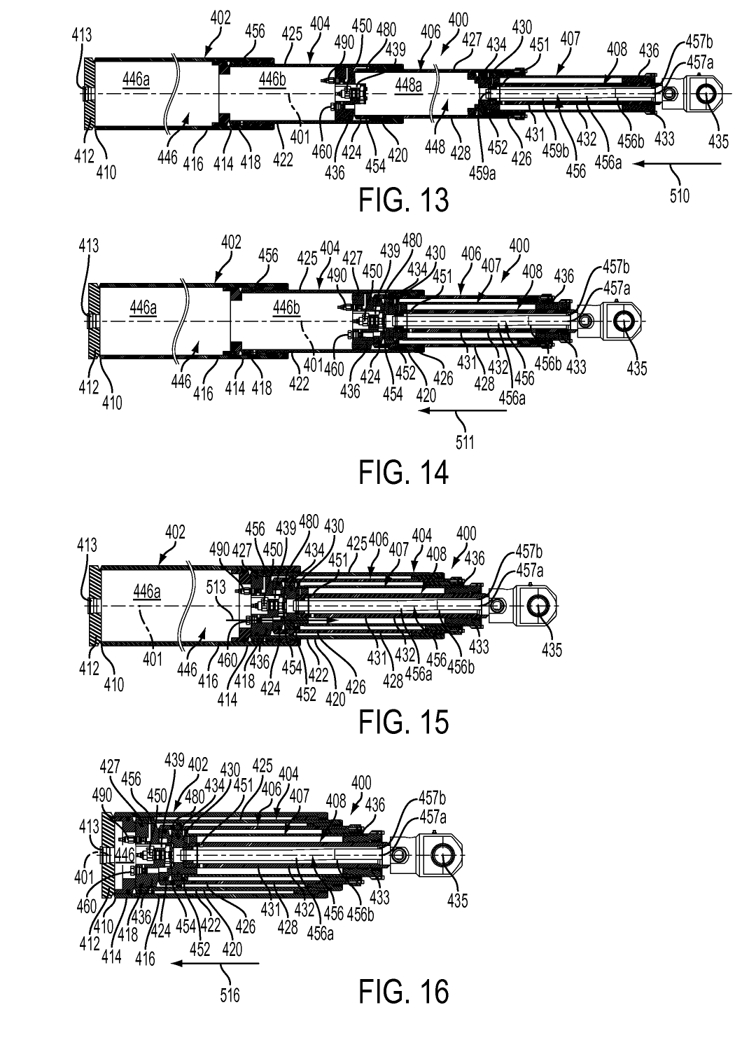

A first opening 451 is disposed in the piston rod 408 and allows fluid to flow between of the second duct 456b and the fourth side chamber 431. A second opening 452 is disposed in the side wall 432 of the third sleeve 407. The second opening 452 is active only when the piston 408 is completely retracted within the third sleeve 407 (as shown in FIG. 13). In that position, the opening 452 communicates with the third side chamber 429. A third opening 454 is disposed in the side wall 422 of the second sleeve 406. The third opening 454 is controlled by a check valve 480. The check valve 480 is a unidirectional valve that allows actuating fluid to flow from the third side chamber 429 to the second side chamber 427. The third opening 454 is active only when the third sleeve 407 is completely retracted within the second sleeve 406 (as shown in FIG. 14). A fourth opening 456 is disposed in the side wall 422 of the first sleeve 404. The fourth opening 456 is active only when the first sleeve 404 is fully retracted in the housing 402 (as shown in FIG. 15). When the telescopic cylinder 400 is in a fully retracted position (as shown in FIG. 16), the first side chamber 425 and the second side chamber 427 communicate with a relief valve 490. The relief valve 490 allows unidirectional fluid communication from the first and second side chambers 425,427 toward the end chamber 446. Actuating fluid flows through the relief valve 490 during the extension of the first and second sleeves 404,406. Pressure in the central chamber 446 increases and creates a force on the first and second sleeves 404,406 thereby forcing them to extend. As a consequence, pressure in the first and second side chambers 425, 427 builds up since the check valve 480 prevents the actuating fluid from escaping therethrough. When the pressure reaches a predetermined pressure, the relief valve 490 opens and allows actuating fluid to escape toward the end chamber 446. The predetermined pressure is usually determined to be the pressure maximum allows by the telescopic cylinder 400. In on example, the predetermined pressure is 3000 psi.

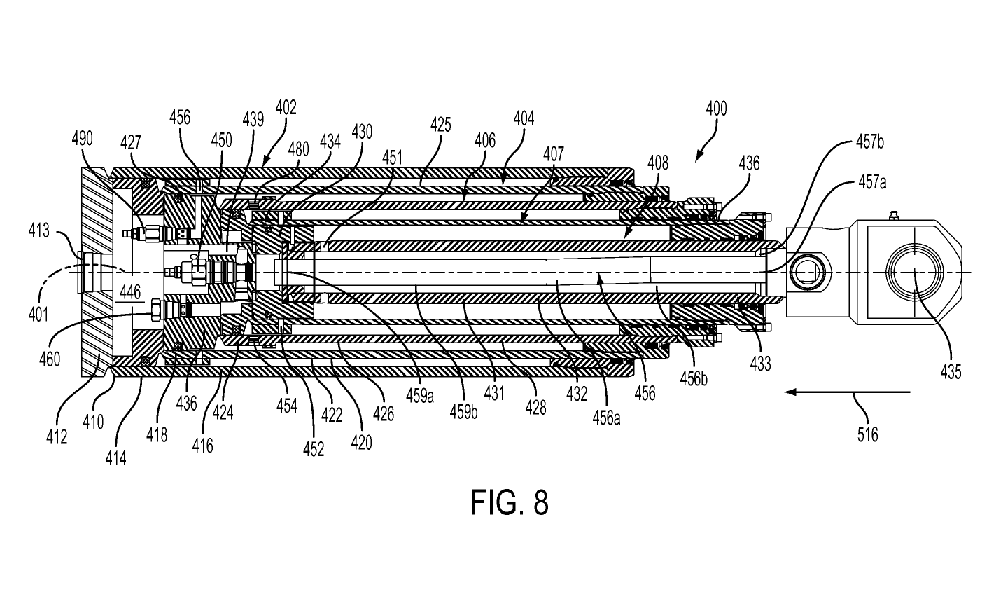

Turning now to FIGS. 8 to 12, a sequence of extension of the telescopic cylinder 400 will be described.

Referring to FIG. 8, the telescopic cylinder 400 is in a fully retracted position. In this position, the telescopic piston 400 has a minimal length. The first ends of the housing 402, first 404, second 406, third 407 sleeves, and of the piston 408 abut each other. It is contemplated that in the fully retracted position, there could be some space between one or more of the first ends of the housing 402, first 404, second 406, third 407 sleeves, and of the piston 408 (an example of which being shown in FIG. 6). The retracted position can also be defined by the position of the telescopic cylinder 400 at the moment when the user stops the injection of actuating fluid in the chamber 446 to start the retraction sequence.

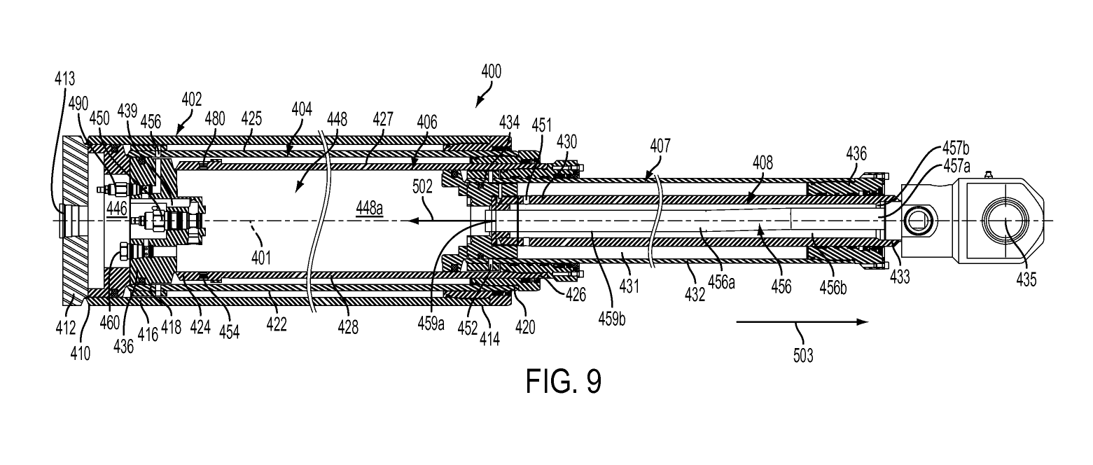

Referring to FIG. 9, as the sequence starts, actuating fluid is introduced in the central chamber 448 through the fluid duct 456a (see arrow 502). The actuating fluid creates pressure on the third sleeve 407 and on the piston 408 thereby extending the third sleeve 407 relative to the second sleeve 406 (illustrated by arrow 503). All the other sleeves 404, 406 remain in their position. The piston 408 has also not substantially moved relative to the third sleeve 407. This is because the surface area of the piston 408 is smaller than the one of the third sleeve 407. As the actuating fluid is introduced in the central chamber 448, the longitudinal motion of the third sleeve 407 inside the second sleeve 406 decreases the volume of the third side chamber 429. Actuating fluid contained in that chamber is forced to escape via the second opening 452 toward the fourth side chamber 431, and then via the first opening 451 towards the second fluid duct 456b. When the third sleeve 407 has extended completely inside the second sleeve 406, the third side chamber 429 has a minimal volume and no more fluid contained there can escape.

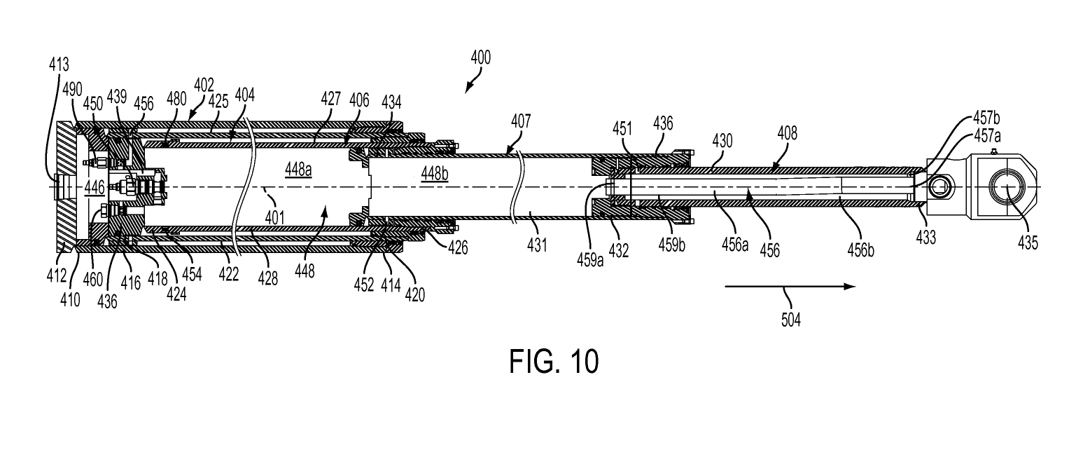

Referring to FIG. 10, the telescopic cylinder 400 is shown in a second partially extended position. Actuating fluid is continuously introduced via a duct 456a. The third sleeve 407 being already fully extended, the piston 408 is now forced to move out relative to the third sleeve 407 (illustrated by arrow 504). Because the pressure of the activating fluid is still below the predetermined pressure, the valve 450 remains closed. The longitudinal motion of the piston 408 inside the third sleeve 407 decreases the volume of the fourth side chamber 431. The actuating fluid contained in that chamber is forced to escape via the first opening 451 towards the second fluid duct 456b.

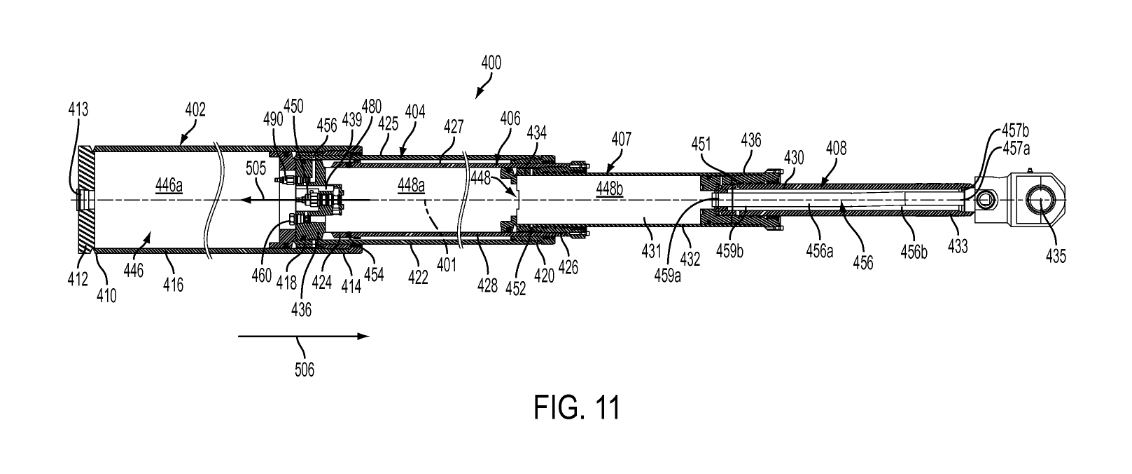

Referring to FIG. 11, once both the third sleeve 407 and the piston rod 408 are fully extended, the pressure from the actuating fluid starts to build inside the central chamber 448, until the pressure inside the central chamber 448 reaches the predetermined pressure threshold, which causes the sequence valve 450 to open (illustrated by arrow 505). Fluid begins to flow through the valve 450 thereby creating the end chamber 446 and moving out the first sleeve 404 relative to the housing 402 (illustrated by arrow 506). Should the actuating fluid be on purpose at a pressure lower than the predetermined pressure threshold, the valve 450 would not open, and the telescopic cylinder 400 would remain as illustrated in FIG. 10. For the same reasons as described above, the first sleeve 404 moves relative to the housing 402 while the second sleeve 406 has substantially no motion relative to the first sleeve 404. The longitudinal motion of the first sleeve 404 inside the housing 402 has decreased the volume of the first side chamber 425. The actuating fluid is forced to escape that chamber via the relief valve 490 into the end chamber 446.

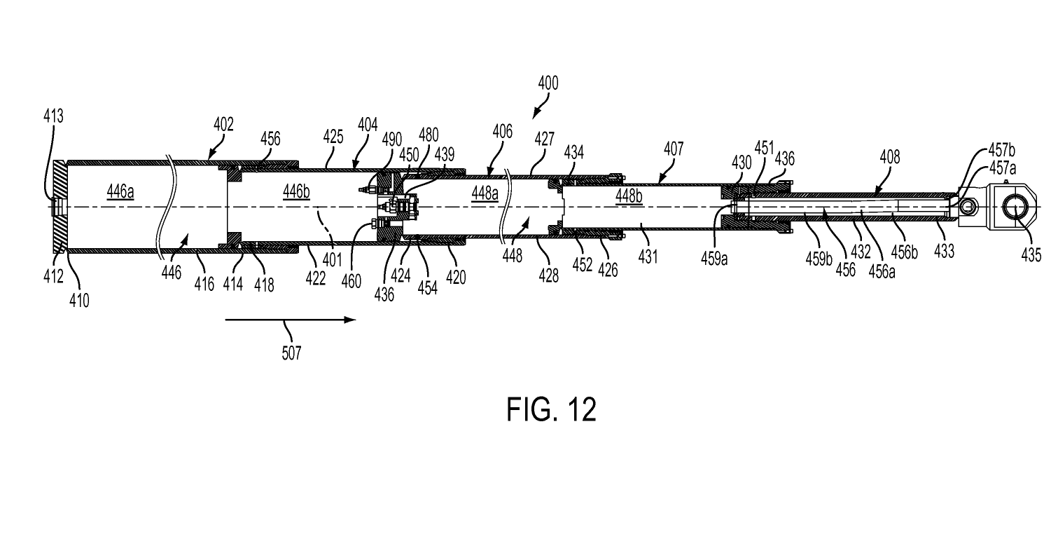

Referring to FIG. 12, the actuating fluid continues to enter the end chamber 446 through the open valve 450 and moves the dividing wall 436 away from the end wall 412. The longitudinal motion of the second sleeve 406 inside the first sleeve 404 decreases the volume of the second side chamber 427. The actuating fluid is forced to escape that chamber via the relief valve 490 into the end chamber 446. As a result, the second sleeve 406 extends within the first sleeve (illustrated by arrow 507). The telescopic cylinder 400 is now in a fully extended position. It will be understood that the term “fully extended” as used herein in relation with FIG. 12 means that the second and third sleeves 406, 407 and the piston rod 408 are fully extended, and that the first sleeve 404 is fully extended.

Turning now to FIGS. 13 to 16, a retraction sequence of the cylinder 400 will be described. To retract the telescopic cylinder 400 from the fully extended position shown in FIG. 12, actuating fluid is stopped from being introduced in the fluid duct 456a, and is instead introduced in the fluid duct 456b. As a result, the side chambers 425, 427, 429, 431 will expand and push the sleeves 404, 406, 407 and the piston 408 back within each other.

More specifically and referring to FIG. 13, as fluid is being introduced in the duct 456b, the actuating fluid enters the fourth side chamber 431 via the opening 451. The actuating fluid forces the fourth side chamber 431 to expand thereby pushing the piston 408 longitudinally back within the third sleeve 407 (illustrated by arrow 510). As the fourth side chamber 431 expands, the second sub-chamber 448b decreases in volume, and actuating fluid flows out of the second sub-chamber 448b toward the reservoir via the second end 459a of the fluid duct 456a until the second sub-chamber 448b disappears.

At this stage only the fourth side chamber 431 is impacted by the addition of the actuating fluid, since the opening 452 does not communicate with the fourth side chamber 431. The opening 452 will communicate with the fourth side chamber 431 only when the piston 408 will be fully retracted in the third sleeve 407. At that point, actuating fluid is allowed to enter the third side chamber 429 thereby expanding the third side chamber 429 and forcing the third sleeve 407 (and the piston 408) to move back inside the second sleeve 406.

Referring to FIG. 14, as the third side chamber 429 expands (illustrated by arrow 511), the first sub-chamber 448a decreases in volume, and actuating fluid flows out of the first sub-chamber 448a toward the reservoir via the second end 459a of the fluid duct 456a. Once the third side chamber 429 has expanded fully and the third sleeve 407 is fully retracted in the second sleeve 406, the third side chamber 429 communicates with the opening 454.

Referring to FIG. 15, actuating fluid enters the second side chamber 427 via the check valve 480. As the second side chamber 427 expands, the second end chamber 446b decreases in volume, and actuating fluid flows out of the second end chamber 446b through the check valve 460 toward the reservoir via the second end 459a of the fluid duct 456a (illustrated by arrow 513).

Referring to FIG. 16, once the second side chamber 427 has expanded fully and the second sleeve 406 is fully retracted in the first sleeve 404, the second side chamber 427 communicates with the opening 456, thus allowing fluid to enter the first side chamber 425. As the first side chamber 425 expands, the first end chamber 446a decreases in volume, retracting the first sleeve 404 inside the housing 402 (illustrated by arrow 516) and actuating fluid flows out of the first end chamber 446s through the valve 460 toward the reservoir via the second end 459a of the fluid duct 456a.

A skilled person will appreciate that, similarly to the telescopic cylinder 100, by allowing the third sleeve 407 and the piston rod 408 to extend before the first and second sleeves 404, 406, the telescopic cylinder 400 allows the user to stop extension of the telescopic cylinder 400 before the first sleeve 404 and/or the second sleeve 406 extend. This allows less actuating fluid to be used in operations in which a shorter stroke is needed, while still allowing a longer stroke to be obtained by providing more pressure to let the valve 450 open. In the case of the trash compacting system for example, the extension/retraction of the second sleeve 406 may be used for 99% of the time, while the full extension/retraction of the telescopic cylinder 400 may be used only for 1% of the time.

It will also be appreciated that since the housing 402 has a larger diameter than the second sleeve 406, it would require a larger volume of actuating fluid to extend the first sleeve 404 by a certain distance than to extend the third sleeve 407 by the same distance. Therefore, if the user does not want the telescopic cylinder 400 to be fully extended, but only wants to extend two sleeves to obtain a shorter stroke, it may be advantageous to extend only the third sleeve 407 and the piston rod 408 instead of the first sleeve 404 and the second sleeve 406 since less actuating fluid would be required.

Furthermore, it will also be appreciated that instead of being positioned at the first end 428 of the second sleeve 406, the dividing wall 436 may be positioned at the first end 434 of the third sleeve 407, in which case the piston rod 408 would extend first, followed by the first sleeve 404, the second sleeve 406 and the third sleeve 407. In another example, the dividing wall 436 may be positioned at the first end 418 of the first sleeve 404, in which case the second sleeve 406 would extend first, followed by the third sleeve 407, the piston rod 408 and the first sleeve 404.

In embodiments where the telescopic cylinder 400 has more than two sleeves, the dividing wall 436 may be positioned at the first end of any sleeve. It is also contemplated that each sleeve of the telescopic cylinder could comprise a dividing wall with an associated valve, such that the sleeves extend sequentially from the piston rod to the most external movable sleeve.

It is also contemplated that the relief valve 480 and the check valve 490 could be omitted. In such configuration, there may be additional delay during retraction. The delay is caused by actuating fluid transfer from the side chambers 425, 427 to the end chamber 448, thereby creating an extension of the first and second sleeves 404, 406 even when the actuating fluid is injected to retract the telescopic cylinder 400. During that time the overall length of the telescopic cylinder 400 does not change.

Modifications and improvements to the above-described embodiments of the present may become apparent to those skilled in the art. The foregoing description is intended to be exemplary rather than limiting. The scope of the present is therefore intended to be limited solely by the scope of the appended claims.

1. A telescopic cylinder comprising:
a housing having a closed housing end and an opposed open housing end;
a first sleeve coaxially nestable at least partially inside the housing, the first sleeve being movable in translation relative to the housing, the first sleeve having a first end located proximate to the closed housing end and an opposed second end;
a second sleeve coaxially nestable at least partially inside the first sleeve, the second sleeve being movable in translation relative to the housing and the first sleeve, the second sleeve having a first end proximate to the first end of the first sleeve, and an opposed second end;
a piston rod coaxially nestable at least partially inside the second sleeve, the piston rod being movable in translation relative to the housing, the first sleeve and the second sleeve;
a dividing wall being disposed at at least one of the first ends of the first and second sleeves, the dividing wall defining a first chamber between the housing and the at least one of the first ends of the first and second sleeves, and a second chamber between the at least one of the first ends of the first and second sleeves and the piston rod; and
a valve extending through the dividing wall for selectively allowing communication from the second chamber to the first chamber when pressure inside the second chamber is above a predetermined pressure.

2. The telescopic cylinder of claim 1, wherein the valve includes an override position, in the override position, the valve allows communicating from the second chamber to the first chamber regardless of the pressure inside the second chamber.

3. The telescopic cylinder of claim 1, wherein the closed housing end includes an aperture aligned with the valve, and a cover selectively sealing the aperture.

4. The telescopic cylinder of claim 1, wherein the piston rod includes a duct allowing fluid communication between the central chamber and a reservoir.

5. The telescopic cylinder of claim 1, wherein the telescopic cylinder is a single action cylinder.

6. The telescopic cylinder of claim 1, further comprising a check valve disposed in the at least one of the first ends of the first and second sleeves comprising the dividing wall, the check valve allowing unidirectional flow from the first chamber to the second chamber.

7. The telescopic cylinder of claim 1, wherein the piston rod includes a bore for connecting to a structure to be moved relative to the housing.

8. The telescopic cylinder of claim 1, further comprising a first side chamber disposed longitudinally between the housing and the first sleeve;
a second side chamber disposed longitudinally between the first sleeve and the second sleeve; and
a third side chamber disposed longitudinally between the second sleeve and the piston rod.

9. The telescopic cylinder of claim 8, wherein the first side chamber communicates with the second side chamber only when the second sleeve is fully nested within the first sleeve; and
the second side chamber communicates with the third side chamber only when the piston rod is fully nested within the second sleeve.

10. The telescopic cylinder of claim 8, further comprising a check valve disposed in the at least one of the first and second sleeves comprising the dividing wall, the check valve allowing fluid communication unidirectionally between associated side chambers disposed adjacent to the at least one of the first and second sleeves; and
a relief valve disposed in the first end of the at least one of the first and second sleeves comprising the dividing wall, the relief valve allowing fluid communication unidirectionally between at least one of the side chambers disposed between the housing and the at least one of the first and second sleeves, and the first chamber.

11. The telescopic cylinder of claim 10, wherein the relief valve allows fluid communication when pressure in the at least one of the side chambers disposed between the housing and the at least one of the first and second sleeves is above a second predetermined pressure.

12. The telescopic cylinder of claim 11, wherein the predetermined pressure of the valve extending through the dividing wall is a first predetermined pressure;
the predetermined pressure of the relief valve is a second predetermined pressure; and
the second predetermined pressure is higher than the first predetermined pressure.

13. The telescopic cylinder of claim 8, further comprising a check valve disposed in the at least one of the first ends of the first and second sleeves comprising the dividing wall, the check valve allowing unidirectional flow from the first chamber to the second chamber.

14. The telescopic cylinder of claim 8, wherein the piston rod includes a first duct allowing fluid communication between the central chamber and a control valve, and a second duct allowing fluid communication between the third side chamber and the control valve.

15. The telescopic cylinder of claim 14, wherein the first and second ducts are coaxial.

16. A method of extending a telescopic cylinder including a housing and at least first and second sleeves, the at least first sleeve being movable in translation within the housing and being at least partially nestable within the housing, the at least second sleeve being movable in translation and at least partially nestable within the at least first sleeve, the method comprising the step of:
extending the at least second sleeve before extending the at least first sleeve.
